(19) United States
(12) Patent Application Publication
(10) Pub. No.: US 2010/0054202 A1
(43) Pub. Date: Mar. 4, 2010

(54) INTERFERENCE CONTROL AND RESOURCE ALLOCATION IN A LOCALIZED BASE STATION ENVIRONMENT

(75) Inventors: Tejas Bhatt, Mountain View, CA (US); Shashikant Maheshwari, Irving, TX (US)

Correspondence Address: BRAKE HUGHES BELLERMANN LLP, c/o CPA Global, P.O. BOX 52050, MINNEAPOLIS, MN, 55402, US

(73) Assignee: NOKIA SIEMENS NETWORKS OY, Espoo (FI)

(21) Appl. No.: 12/535,907

(22) Filed: Aug. 5, 2009

Related U.S. Application Data
(60) Provisional application No. 61/086,719, filed on Aug. 6, 2008.

(51) Int. Cl. H04W 72/04

(52) U.S. Cl. 370/329

(57) ABSTRACT

According to one general aspect, a method, in one embodiment, comprising establishing an indoor cellular access point (ICAP) on a network. In various embodiments, the method may also include co-operatively selecting an ICAP identifier (ID) such that the ICAP ID is unique amongst the ICAP and the NICAPs. In some embodiments, the method may further include sharing a wireless communications resource by multiplexing the use of the wireless communications resource amongst the ICAP and the NICAPs.

This application claims priority from U.S. Provisional Patent Application 61/086,719, filed Aug. 6, 2008, titled “INTERFERENCE CONTROL AND RESOURCE ALLOCATION IN A LOCALIZED BASE STATION ENVIRONMENT,” which is incorporated herein by reference in its entirety.

### TECHNICAL FIELD

This description relates to mobile communication technology, and more specifically to the interference control and resource allocation in a localized base station environment.

### BACKGROUND

Typically, wireless networks include a base station that generally couples a wired network with a wireless network and mobile station that uses the wireless network. Often these two devices are in direct communication. However, multiple wireless network standards are in use or development. Due to the ranged nature of wireless networks, it is possible that a mobile station may be connected to or in the range of a number of wireless networks.

Worldwide Interoperability for Microwave Access (WiMAX) is a telecommunications technology often aimed at providing wireless data over long distances (e.g., kilometers) in a variety of ways, from point-to-point links to full mobile cellular type access. A network based upon WiMAX is occasionally also called a Wireless Metropolitan Access Network (WirelessMAN or WMAN); although, it is understood that WMANs may include protocols other than WiMAX. WiMAX often includes a network that is substantially in compliance with the IEEE 802.16 standards, their derivatives, or predecessors (hereafter, “the 802.16 standard”). Institute of Electrical and Electronics Engineers, IEEE Standard for Local and Metropolitan Area Networks, Part 16, IEEE Std. 802.16-2004.

One particular derivative of the 802.16 standard is the 802.16e standard that addresses mobility. Institute of Electrical and Electronics Engineers, IEEE Standard for Local and Metropolitan Area Networks, Part 16, Amendment 2, IEEE Std. 802.16e-2005.

One particular derivative of the 802.16 standard is the, as yet finished, 802.16m standard that attempts to increase the data rate of wireless transmissions to 1 Gbps while maintaining backwards compatibility with older networks. IEEE 802.16 Broadband Wireless Access Working Group, IEEE 802.16m System Requirements, Oct. 19, 2007.

In telecommunications, an indoor cellular access point (ICAP) (a.k.a. a femtocell, femto access point (AP), femto base station (BS), home node B (HNB), pico BS, AP BS, etc.) is generally a small cellular base station, that is typically designed for use in residential or small business environments. It often connects to the service provider's network via broadband (e.g., DSL, cable, T1 line, fiber, etc.). An ICAP typically allows service providers or customers to extend service coverage indoors, especially where access would otherwise be limited or unavailable. Although it is understood that the ICAP may be used outdoors, ICAPs are usually placed indoors due in part to the attenuation caused by walls and other structures. Often an ICAP incorporates the functionality (in whole or part) of a typical base station but extends it to allow a simpler, self contained deployment. For example, a business may choose to install one or more ICAPs through-out their building to provide better service to their employees. Although currently much attention is focused on third generation (3G) cellular technology, the concept is applicable to all standards, including WiMAX solutions.

### SUMMARY

According to one general aspect, a method, in one embodiment, comprising establishing an indoor cellular access point (ICAP) on a network. In various embodiments, the method may also include co-operatively selecting an ICAP identifier (ID) such that the ICAP ID is unique amongst the ICAP and at least one neighboring ICAP (NICAP). In some embodiments, the method may further include sharing a wireless communications resource by multiplexing the use of the wireless communications resource amongst the ICAP and the NICAPs.

According to another general aspect, an apparatus may comprise, in one embodiment, a wireless transceiver, a controller, and a memory. In various embodiments, the wireless transceiver may be configured to establish the apparatus on a network. In some embodiments, the wireless transceiver may also be configured to share a wireless communications resource by multiplexing the use of the wireless communications resource amongst the apparatus and at least one neighboring ICAP (NICAP). In various embodiments, the controller configured to co-operatively select an ICAP identifier (ID) such that the ICAP ID is unique amongst the apparatus and the NICAPs. In various embodiments, the memory configured to store the ICAP ID.

The details of one or more implementations are set forth in the accompanying drawings and the description below. Other features will be apparent from the description and drawings, and from the claims.

A system and/or method for communicating information, substantially as shown in and/or described in connection with at least one of the figures, as set forth more completely in the claims.

### BRIEF DESCRIPTION OF THE DRAWINGS

FIG. 1 is a block diagram of an example embodiment of a system in accordance with the disclosed subject matter.

FIG. 2 is a block diagram of an example embodiment of a system in accordance with the disclosed subject matter.

FIG. 3 is a block diagram of example embodiments of two apparatuses in accordance with the disclosed subject matter.

FIG. 4 is a block diagram of an example embodiment of a system in accordance with the disclosed subject matter.

FIG. 5 is a block diagram of an example embodiment of a system in accordance with the disclosed subject matter.

FIG. 6 is a block diagram of an example embodiment of a system in accordance with the disclosed subject matter.

FIG. 7 is a flow chart of an example embodiment of a technique in accordance with the disclosed subject matter.

### DETAILED DESCRIPTION

Referring to the Figures in which like numerals indicate like elements,

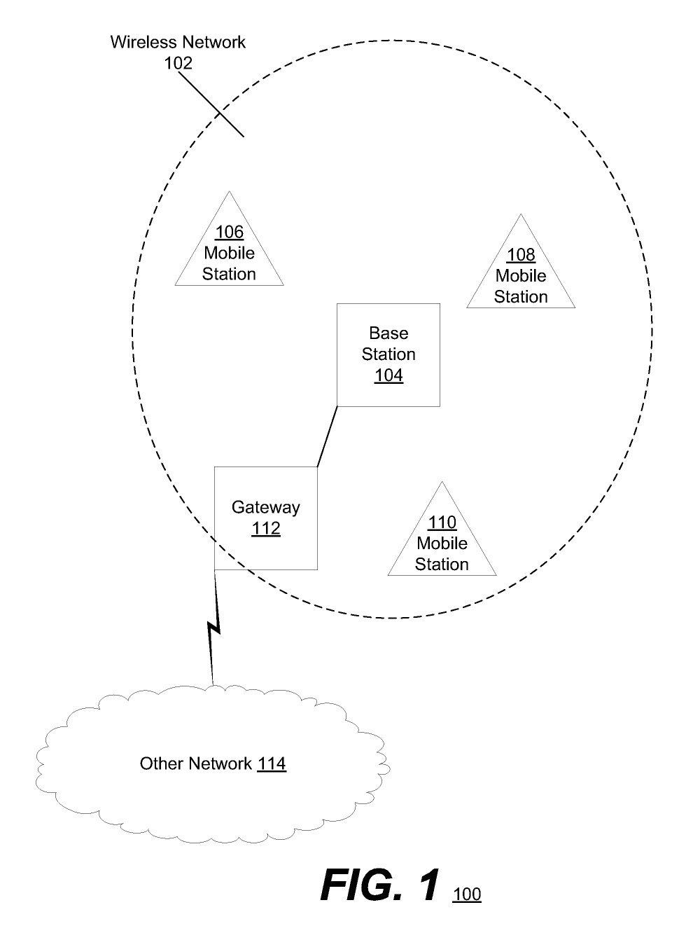

FIG. 1 is a block diagram of a wireless network 102 including a base station (BS) 104 and mobile stations (MSs) 106, 108, 110, according to an example embodiment. Each of the MSs 106, 108, 110 may be associated with BS 104, and may transmit data in an uplink direction to BS 104, and may receive data in a downlink direction from BS 104, for example. Although only one BS 104 and three mobile stations (MSs 106, 108 and 110) are shown, any number of base stations and mobile stations may be provided in network 102. Also, although not shown, mobile stations 106, 108 and 110 may be coupled to base station 104 via relay stations or relay nodes, for example. The base station 104 may be connected via wired or wireless links to another network 114, such as a Local Area Network, a Wide Area Network (WAN), the Internet, etc. In various embodiments, the base station 104 may be coupled or connected with the other network 120 via an access network controller (ASN) or gateway (GW) 112 that may control, monitor, or limit access to the other network.

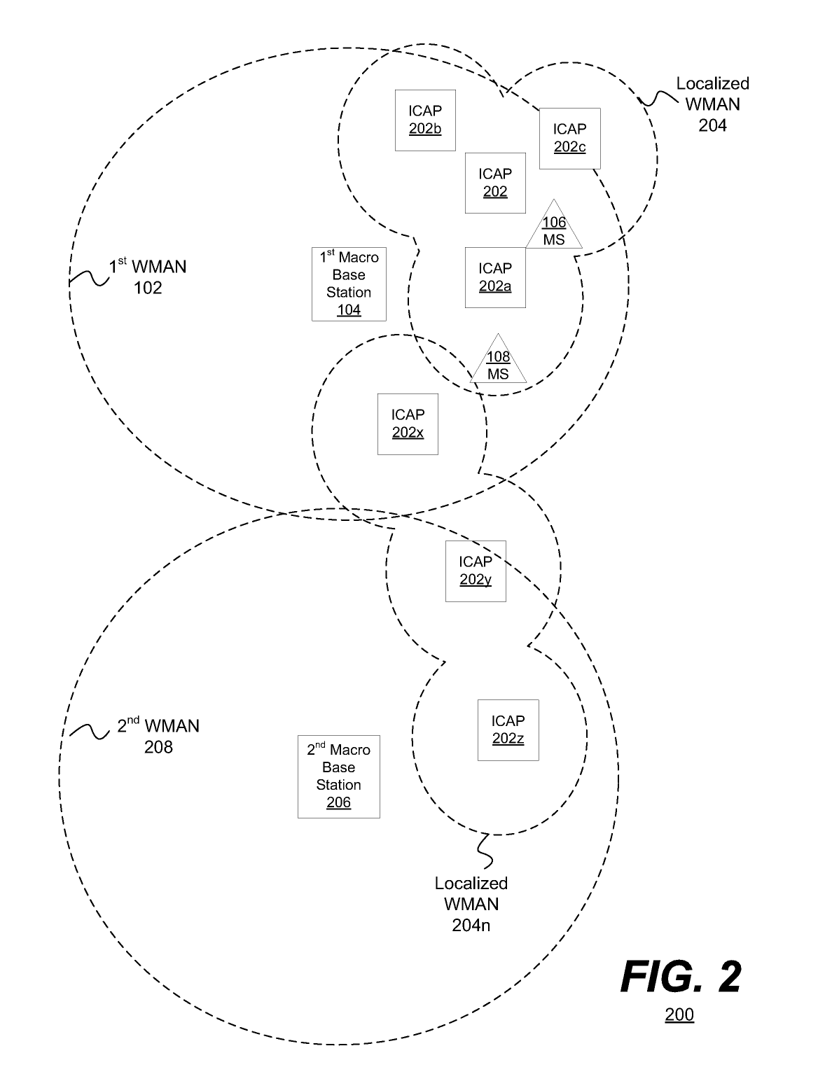

FIG. 2 is a block diagram of an example embodiment of a system 200 in accordance with the disclosed subject matter. In various embodiments, the system may include a BS 104, a MS 106, and a number of ICAPs 202, 202a, 202b, and 202c. In various embodiments, the BS 104 may be a macro BS (MBS) that is configured to provide WMAN 102 converge over a range measured in kilometers (e.g., 0.5-50 km, etc.) or decibels per milliwatts (e.g., 45 dBm, etc.). In contrast, in one embodiment, each ICAP 202 may be configured to provide a localized WMAN (e.g., WMAN 204 and 204n) measured in meters (e.g., 500 m, 50 m, etc.) or decibels per milliwatts (e.g., 30 dBm, 15 dBm, etc.).

In various embodiments, the MS 106 may make use of the WMAN 102 provided by BS 102 when the MS is outside of the range of the ICAPs 202. As the MS enters the range of the localized WMAN 204 provided by the ICAPs 202, 202a, 202b, and 202c, the MS 106 may wish to handover or transfer from the BS 102 to the ICAP 202a. In various embodiments, this may provide the MS 106 with better service or a lower cost of communication; although, it is understood that the above are merely a few illustrative examples to which the disclosed subject matter is not limited. It is noted that localized WMAN 204 includes the union of the ranges of ICAPs 202, 202a, and 202b, which could have been represented as three separate localized WMANs. In some embodiments, the system 200 may also include the localized WMAN 204n, which includes or is provided by the ICAPs 202x, 202y, and 202z. The system 200 may include the MBS 206 and the WMAN 208. In various embodiments, the MS 106 as a mobile device may move between these networks.

In various embodiments, the MS 106 may be within range of multiple ICAPs (e.g., ICAP 202, 202a, and 202c). In some embodiments, other MSs may also be connected or in communication with one or more of these ICAPs. MS 106 represents any such other MSs. In such an embodiment, the ICAPs may all transmit and receive messages via the same communications channel or frequency range.

In most typical cases, an ICAP 202 may be deployed by an operator in licensed frequency band that is either same or separate from the frequency band of the MBS 104. However, as the number of deployed ICAPs increases the likelihood of cross-ICAP interference increases. Various ICAPs (e.g., ICAPs 202, 202a, 202b, & 202c) may all attempt to communicate using the same communications channel. This may result in an unintentional mixing of messages or other noise or interference. Such interference may seriously degrade the performance of the WMAN 204.

In various embodiments, an operator or ICAP end-user may manually re-configure the ICAPs 202, 202a, 202b, and 202c to use different frequencies. In some cases, a similar system is used by Wi-Fi access point operators. However, in various embodiments, a single operator may not have control of all the interfering ICAPs. For example, localized WMAN 204n may overlap with localized WMAN 204. These localized WMANs 204 and 204n may be operated by different companies and, therefore, manual configuration may prove difficult.

In various embodiments, the ICAP 202 may be established on a network (e.g., localized WMAN 204). In various embodiments, the ICAPs 202, 202a, 202b, and 202c may co-operatively select an ICAP ID for the ICAP 202 such that the ICAP ID is unique amongst the four ICAPs 202, 202a, 202b, and 202c. In various embodiments, the ICAP ID may then be used to share a wireless communication resource (e.g., a frequency band, time slots, resource blocks, frames, sub-frames, etc.) between the four ICAPs 202, 202a, 202b, and 202c. Such self-organization is described in more detail below.

In various embodiments, the ICAP 202 may transmit its ICAP ID during a management/control or data communication message. In some embodiments, this ICAP ID may be part of a preamble ID or, in one embodiment, part of a cell ID. In various embodiments, a connected MS (e.g., MS 106) may be configured to look for and only respond to messages containing the ICAP ID of the ICAP (e.g., ICAP 202) with which the MS is associated and in communication. In such an embodiment, the self-organizing and resource sharing scheme described below may utilize the ICAP ID. However, it is understood that the use of the ICAP ID is merely one embodiment to which the disclosed subject matter is not limited and other identification or allocation techniques may be used.

In various embodiments, the ICAPs of the localized WMAN (e.g., ICAPs 202, 202a, 202b, and 202c) may be coupled to a central indoor cellular gateway (ICGW). In various embodiments, the ICGW may be represented by GW 112 of FIG. 1. In various embodiments, the ICGW may be used to co-ordinate the selection of an ICAP ID and/or resource sharing.

In such an embodiment, the ICAPs 202 et al. may be configured to share neighbor information with the ICGW. In various embodiments, an ICAP 202 may be configured to scan for a list of neighboring or in range MBSs or ICAPs. In some embodiments, these neighboring devices may be added to a neighbor list to reduce the use of resources involved in scanning the environment. In another embodiment, the neighbor list may be pre-configured into the ICAP 202.

In one embodiment, each of the ICAPs 202 et al. may be configured to transmit communication load and/or other performance and communication resource information to the ICGW. In various embodiments, this communication may occur via a wireless or wired link between the ICGW and the ICAP. In one embodiment, the communications link may be the same communications link used to transmit information between the ICAP and the ICGW that is related to the other network (e.g., other network 114 of FIG. 1). In another embodiment, such performance related communication may utilize an out-of-band communications channel.

In various embodiments, the ICGW may allocate communications resources to the ICAPs 202 et al based upon the neighbors of each ICAP. In some embodiments, the ICGW may allocate and share communications resources such that interference between ICAPs is minimized. For example, the ICGW may prevent ICAPs 202 and 202a from transmitting simultaneously or on the same channel, but may not prevent ICAPs 202 and 202z from doing so, as ICAPs 202 and 202z are not within each other's range any therefore may not interfere; although, it is understood that the above is merely one illustrative example to which the disclosed subject matter is not limited.

In various embodiments, the ICAPs 202 et al. may communicate and co-ordinate directly with one another. In such an embodiment, an ICAP 202 may communicate directly with neighboring ICAPs (NICAPs, e.g., 202a 202b, and 202c). In various embodiments, a set of code division multiple access (CDMA) ranging codes or other message formats may be created to facilitate this communication.

In various embodiments, the ICAP 202 and its NICAPs 202a, et al. may receive or be aware of each other's ICAP ID. In various embodiments, this may occur by scanning the NICAPs or based upon receipt of measurement information received from MS. In some embodiments, the ICAP 202 may change or set its ICAP ID such that the ICAP ID is unique amongst the ICAP 202 and its NICAPs 202a et al. In various embodiments, the neighbors of the NICAPs (e.g., ICAP 202x of ICAP 202a) may be considered in determining the selection of the ICAP ID. In such an embodiment, it may be desirable to select the ICAP ID of the NICAP 202a such that it is unique amongst all of ICAP 202a's neighbors (the ICAPs 202b, 202c, 202, and the ICAP 202x).

In one embodiment, the neighbor list provided by an ICAP 202a may include a list of the ICAP's 202a neighboring ICAPs (the ICAPs 202b, 202c, and 202, and the ICAP 202x). In one embodiment, the ICAP 202a may add the neighboring ICAPs to the neighbor list, and identify the ICAPs as NICAPs on the neighbor list. In various embodiments, this may be done by using a special field or adding the NICAPs within a different field from other signal stations or devices on the neighbor list. In such an embodiment, an ICAP (e.g., ICAP 202) may request or receive the ICAP's 202a neighbor list periodically or as part of the network establishment procedure. In various embodiments, the neighbor list may be used by ICAP 202 to aid the selection of a unique ICAP ID and/or sharing a wireless communications resource.

In various embodiments, the ICAP ID may be used to partition or divide a communications resource amongst the ICAP 202 and the NICAPs 202a et al. In various embodiments, there may be a number (n) of ICAPs within an interfering range. The ICAP IDs may be chosen such that each ICAP ID produces a unique and sequential value for the operation ICAP ID modulo n. For example, if four ICAPs (e.g., ICAPs 202, 202a, 202b, and 202c) are within range of each other their ICAP IDs may be chosen such that the remainder of the ICAP ID divided by four would equal 0, 1, 2, or 3. In such an embodiment, the ICAP 202 may be given an ICAP ID of 1. ICAP 202a may be given an ICAP ID of 2. ICAP 202b may be given an ICAP ID of 3. ICAP 202c may be given an ICAP ID of 4 (i.e., a remainder of 0 if the ICAP ID is divided by 4). In such an embodiment, each ICAP ID may be sufficiently unique within the system of the ICAP and its NICAPs. Although, it is understood that the above are merely a few illustrative examples to which the disclosed subject matter is not limited.

In various embodiments, the ICAPs 202 et al. may then share a wireless communications resource by multiplexing the use of the wireless communications resources amongst the ICAP 202 and its NICAPs 202a et al. In some embodiments, the multiplexing may include frequency division multiplexing, or time division multiplexing (in various embodiment, by sub-frame or frame), a combination thereof, etc.

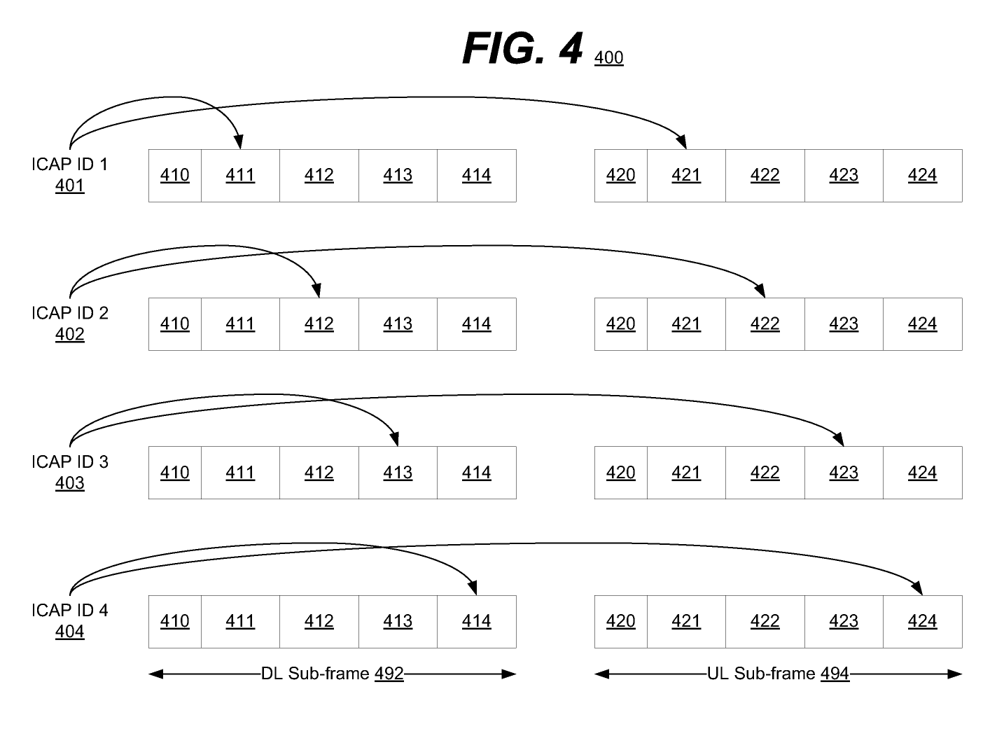

FIG. 4 is a block diagram of an example embodiment of a system 400 in accordance with the disclosed subject matter. In various embodiments, the system 400 may include four ICAPs 401, 402, 403, and 404, which may be analogous to ICAPs 202, 202a, 202b, 202c of FIG. 2. In various embodiments, the ICAPs may use a frame structure such as used in the 802.16m standard. FIG. 4 illustrates one such frame. In such an embodiment, the ICAPs may transmit information to a MS during a downlink (DL) sub-frame 492. Conversely, data may be received from a MS during an uplink (UL) sub-frame 494.

In various embodiments, the DL sub-frame 492 may be divided into partitions or segments based upon the number of ICAPs. FIG. 4 illustrates a division of four segments and a fifth starting common partition. In various embodiments, the common partition 410 may be used by all ICAPs to transmit broadcast control messages or information, such as, for example, a frame control header (FCH) or a medium access control protocol (MAP) message (e.g., DL-MAP message); although, it is understood that the above are merely a few illustrative examples to which the disclosed subject matter is not limited.

In various embodiments, the remaining portions of the DL sub-frame 492 may be assigned or allocated to the ICAPs. In one embodiment, the assignment scheme may be based upon the ICAP's ICAP ID. For example, ICAP 401 may include an ICAP ID of 1 (or a value that results in a remainder of 1 when divided by 4); therefore, the ICAP 401 may be assigned the first non-common segment 411. Likewise, ICAP 402 with an ICAP ID of 2 may be assigned segment 412. ICAP 403 with an ICAP ID of 3 may be assigned segment 413. And, ICAP 404 with an ICAP ID of 4 may be assigned segment 414.

In various embodiments, the various ICAPs may only communicate with their respective MSs using their assigned segment and any common segment (e.g., 410). For example, the ICAP 401 may transmit during the segment 410 and 411, but not communicate during the segments 412, 413, and 414. Therefore, the communications resource or channel may be free of interference from ICAP 401 during the segments 412, 413, and 414. Likewise, for the ICAPs 402, 403, and 404. In such an embodiment, interference between the four ICAPs may be reduced.

In some embodiments, a message may be transmitted to the MS(s) associated with the respective ICAPs informing the MSs of the assigned segments. The MSs, or a portion thereof, may be configured to enter a sleep or inactive mode during a segment that is not assigned to the associated ICAP and then wake-up or listen during the assigned segment. In another embodiment, the MS may simply listen all the time, but use the ICAP ID or other identifier to filter out messages not directed to the MS.

In various embodiments, an uplink (UL) sub-frame 494 may be similarly divided. In various embodiments, the segment 420 may include common portion such as an UL-MAP message or an aligned ranging region, etc. As with the DL sub-frame 492, segment 421 may be allocated to ICAP 401. Segment 422 may be allocated to ICAP 402. Segment 423 may be allocated to ICAP 403. Segment 424 may be allocated to ICAP 404.

In various embodiments, a message may be transmitted to the MSs associated with the respective ICAP informing the MS of the allocated or assigned segment. The MSs may then transmit during the assigned segment. In another embodiment, the MSs transmissions may be control via more traditional resource allocation schemes. For example, in various embodiments, the ICAP 401 may allocate resources to the MS. In such an embodiment, the ICAP 401 may only allocate resources that happen to fall within the segment assigned to ICAP 401.

In various embodiments, the time multiplexing may occur based not on segments of a sub-frame (e.g., DL sub-frame 492 or UL sub-frame 494) but on an entire frame. In such an embodiment, a single ICAP may be assigned all the segments of the DL sub-frame 492 and UL sub-frame 494. Another ICAP may then be assigned the next entire frame, and so on. In such an embodiment, ICAP 401 may transmit every fourth frame. In such an embodiment, each ICAP may have a greater number of resources in each assigned time block, but such an assignment may occur less frequently; therefore, there may be a latency increase between the MS and ICAP pair. In various embodiments, other time blocks or time granularities may be used and it is understood that the above are merely a few illustrative examples to which the disclosed subject matter is not limited.

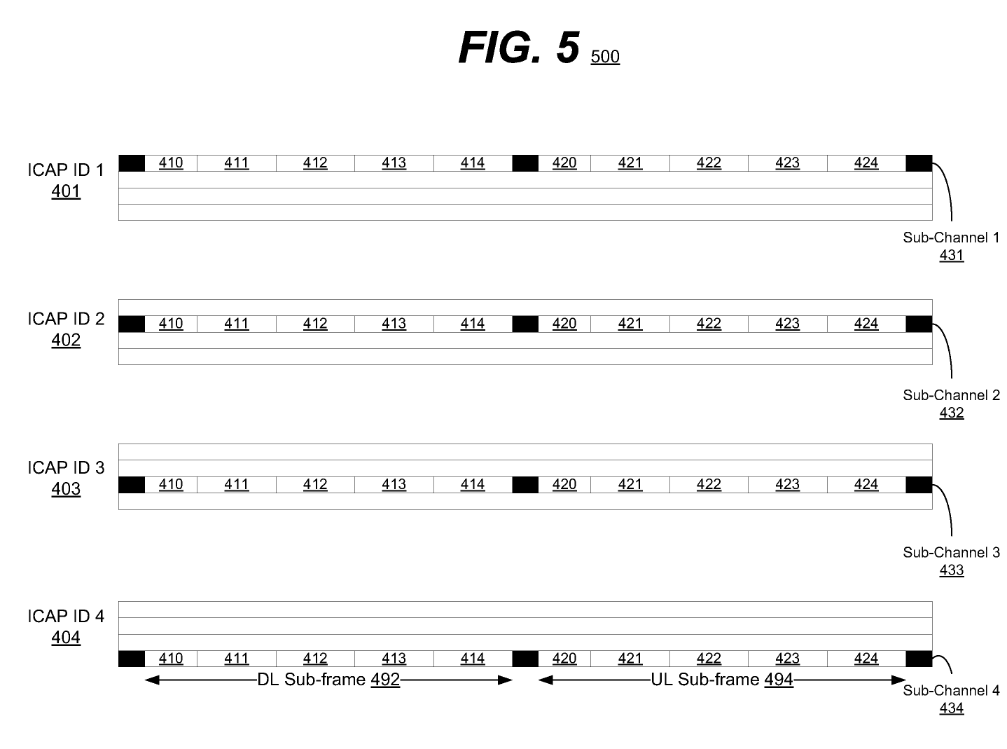

In various embodiments, the wireless communications resource may be multiplexed using a frequency division multiplexing scheme. FIG. 5 is a block diagram of an example embodiment of a system 500 in accordance with the disclosed subject matter. In various embodiments, the system 500 may include the ICAPs 401, 402, 403, and 404. In various embodiments, the wireless communications resource may be divided into a plurality (e.g., four) of sub-channels 431, 432, 433, and 434. In such an embodiment, the aggregate of the sub-channels may include the entire channel available for communication to the ICAPs; however, in another embodiment, a portion of the communications channel may be reserved or unused.

In various embodiments, the ICAPs may be assigned a sub-channel based upon the ICAP's ID; although, it is understood that the above is merely one illustrative example to which the disclosed subject matter is not limited. For example, ICAP 401 with an ICAP ID of 1 may be assigned sub-channel 1 431. ICAP 402 with an ICAP ID of 2 may be assigned sub-channel 2 432. ICAP 403 with an ICAP ID of 3 may be assigned sub-channel 3 433. ICAP 404 with an ICAP ID of 4 may be assigned sub-channel 4 434. In such an embodiment, the bandwidth available to each ICAP may be reduced, but the latency of communication between an ICAP and a MS may be improved.

In various embodiments, each ICAP may transmit an entire DL sub-frame 492 or UL sub-frame 494 using only the portion of the channel, the sub-channel, assigned to the ICAP. This is contrasted with the embodiment of FIG. 4, in which an ICAP may transmit using an entire channel but only a portion of the DL sub-frame 492 or UL sub-frame 494.

In various embodiments, the ICAP may communicate with an associated MS to direct the MS to utilize only the assigned sub-channel. In another embodiment, the MS may simply filter out communication using an unassigned sub-channel using more traditional filtering or resource allocation techniques. In various embodiments, an ICAP may be associated with a variety of MSs, some of which may be capable to understanding a message to utilize only an assigned sub-channel and others that are not capable of understanding such a message and instead utilize a more traditional filtering and resource allocation technique.

In various embodiments, the wireless communications resource may be divided into more or less segments than the number of ICAPs. In some embodiments, this may occur because the there is a minimum level of granularity below which the wireless communications resource may not be divided. In another embodiment, this may occur because the wireless communications resource may only be divided into discrete quanta. In such an embodiment, the segments may be allocated in a round robin fashion, or another scheme. For example, if a channel could only be frequency multiplexed into four sub-channels but five ICAPs where sharing the channel, the sub-channel assignment may change from frame to frame. It is understood that the above are merely a few illustrative examples to which the disclosed subject matter is not limited.

In various embodiments, the ICAP 202 of FIG. 2 may monitor the communications load of the NICAPS 202a, 202b, and 202c. In various embodiments, the ICAPs 202 et al. may be configured to transmit their expected communications load information, for example, via a preamble or other broadcast message (e.g., FCH, MAP, etc.). In various embodiments, if an ICAP 202 has a little or nothing to communicate, it may release its assigned portion of the wireless communications resource and allow another ICAP 202a et al. to make use of resource.

In various embodiments, the ICAP 202 may indentify a NICAP to give the assigned or allocated resource to. In some embodiments, the ICAP 202 may give the assigned resource to the NICAP with the highest or greatest communications load; although other schemes are contemplated. In one embodiment, the receiving ICAP may be ICAP 202a.

In various embodiments, the giving ICAP 202 may transmit a message to the receiving ICAP 202a that indicates that the giving ICAP's 202 resource assignment is being made available to the receiving ICAP 202a. In one embodiment, the message may include an unconditional offer or re-assignment for a set period of time. In some embodiments, the message may include the length of time for which the re-assignment is valid (e.g., 2 seconds, 4 frames, etc.). In another embodiment, the message may be part of an offer/acceptance scheme in which the giving ICAP 202 makes an offer to the receiving 202a and the receiving ICAP 202a must transmit an acceptance. In various embodiments, the unconditional offer/re-assignment embodiment may be preferred as, if acceptance is not received in the other embodiment, two or more ICAPs may attempt to simultaneously use the assigned resource. Likewise, the re-assignment may be for a fixed duration of time (either specified in the message or a pre-defined time period), such that control of the assigned resource partition is guaranteed to revert to the giving ICAP 202. Although, it is understood that the above are merely a few illustrative examples of dynamic resource sharing to which the disclosed subject matter is not limited.

In various embodiments, the MS 106 may be configured to adapt its functioning to the ICAPs' sharing of the wireless communications resource, as described above. In one embodiment, the MS 106 may be configured to determine the portion of the wireless communication resource assigned to the ICAP 202a associated with the MS, based upon the ICAP's ID. In another embodiment, the MS 106 may receive a message from the ICAP 202a indicating that the ICAP is sharing a wireless communications resource and which portion of the shared wireless communication resource is allocated to the ICAP 202a. In some embodiments, the message may be part of establishing or associating the MS 106 with the ICAP 202a (e.g., a ranging response message). In various embodiments, the portion of the message indicating the sharing of the wireless resource may be a new field in an associating message. In one embodiment, the portion indicating which portion of the wireless communications resource is allocated to the ICAP may be the ICAP's ID (e.g., preamble ID, cell ID, BS ID, etc.). Although, it is understood that the above are merely a few illustrative examples to which the disclosed subject matter is not limited.

In various embodiments, the MS 106 may then configure itself to expect communication with the ICAP 202a during the allocated portion of the shared wireless communication recourse. In various embodiments, the ICAP 202a may be assigned a portion for data communication (e.g., segment 412 of FIG. 4) and another portion (e.g., sub-channel 432 of FIG. 5) for broadcast communication (e.g., FCH, MAP messages, segment 410 of FIG. 4, etc.). In various embodiments, these broadcast messages may be reduced in size by removing unnecessary or redundant information. In some embodiments, these allocation portions may be determined based upon the ICAP's ID, as described above. In such an embodiment, a greater number of broadcast messages may be transmitted without interference or with reduced interference than in the embodiment illustrated by FIG. 4 in which all ICAPs simultaneously broadcast their respective broadcast messages (e.g., segment 410). For example, in one specific embodiment, such a system may allow for up to 48 non-overlapping or non-interfering FCH messages (4 slots*4 sub-frames in a frame*4 sectors, if the FCH has been reduced to 1 slot worth of data); although, it is understood that the above is merely one illustrative example to which the disclosed subject matter is not limited.

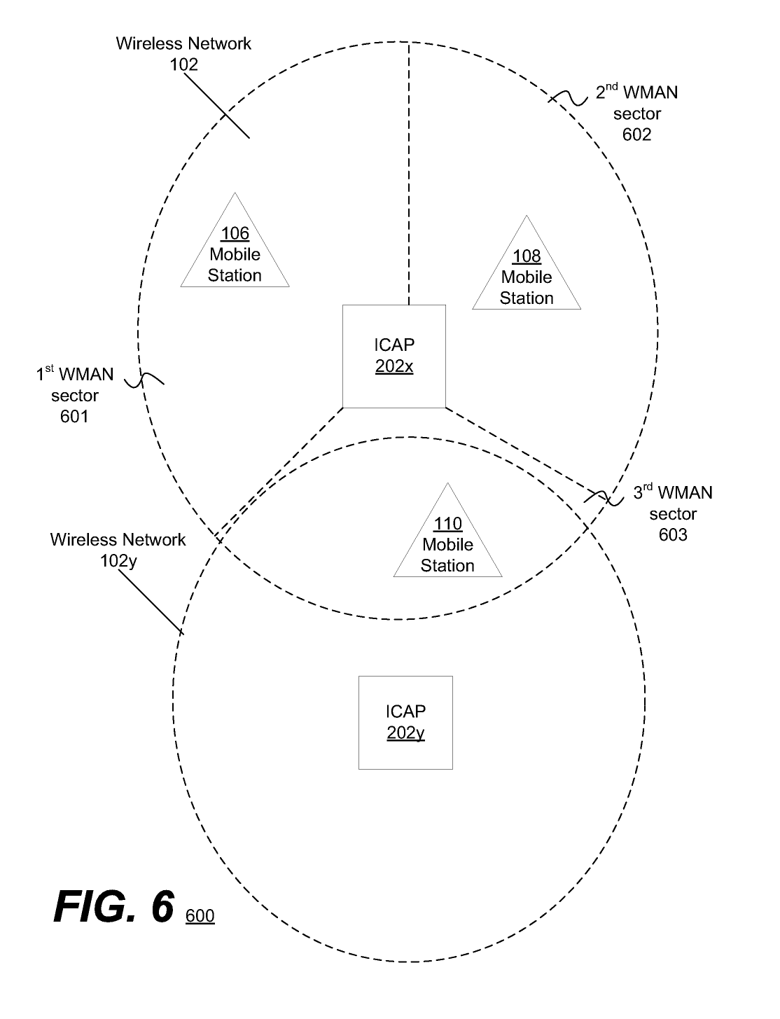

FIG. 6 is a block diagram of an example embodiment of a system 600 in accordance with the disclosed subject matter. In various embodiments, the system 600 may include a plurality of ICAPs 202x and 202y, and a plurality of MSs 106, 108, and 110. FIG. 6 illustrates that, in one embodiment, the communication range provided by the ICAP 202x may be sub-divided into a plurality of sectors.

In many embodiments, an ICAP may use an omni-directional antenna or transceiver. However, in various embodiments, an ICAP (e.g., ICAP 202x) may use a plurality of uni-directional antennas or transceivers. In such an embodiment, the ICAP 202x may split the localized WMAN 102 into sectors (e.g., sector 601, 602, and 603). In various embodiments, the ICAP 202x may allow sharing of a wireless communications resource only on sectors that experience interference from other ICAPs (e.g., ICAP 202y).

For example, in the embodiment illustrated by FIG. 6, ICAP 202x may only experience interference with ICAP 202y within sector 603. In such an embodiment, the first and second WMAN sectors 601 and 602 may not share the wireless communications resource and may communicate with MSs 106 and 108 without the need to multiplex the communication. In various embodiments, the third sector 603 may overlap with the WMAN 102y provided by ICAP 202y. In such an embodiment, the ICAP 202x may share the wireless communication resource of the third sector 603. In various embodiments, the communication occurring between the ICAP 202x and the MS 110 may be time division multiplexed, frequency division multiplexed, a combination thereof, or multiplexed in a different fashion, as described above.

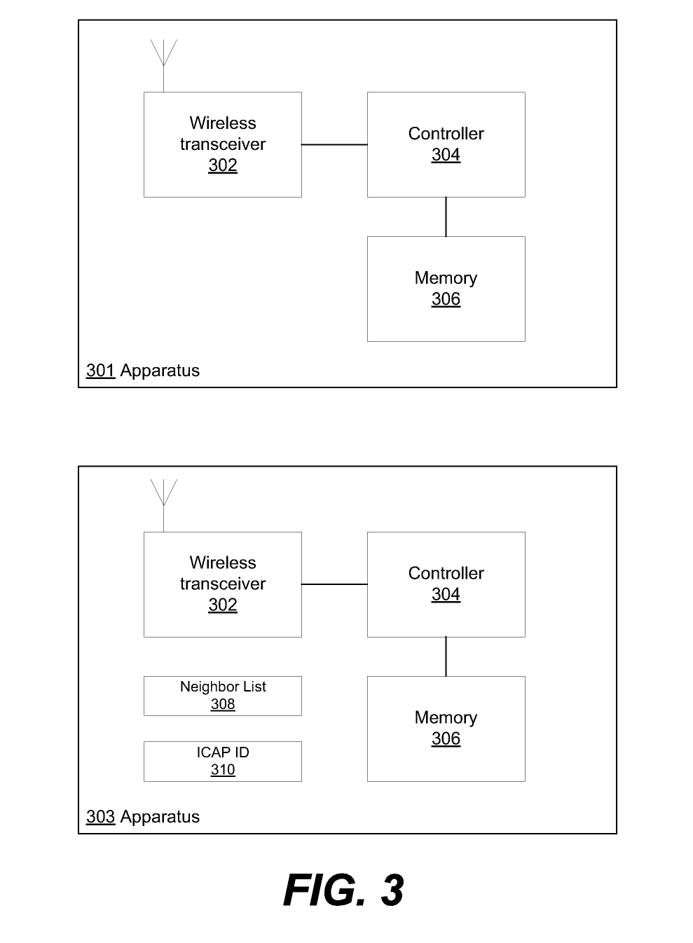

FIG. 3 is also a block diagram of a wireless device 301 in accordance with an example embodiment of the disclosed subject matter. In one embodiment, the wireless device 301 may include an indoor cellular access point (ICAP) or a mobile station (MS) such as that illustrated in FIG. 2. In one embodiment, the wireless device 301 may include a wireless transceiver 302, a controller 304, and a memory 306. In some embodiments, the transceiver 302 may include a wireless transceiver configured to operate based upon a wireless networking standard (e.g., WiMAX, WiFi, WLAN, etc.). In various embodiments, the controller 304 may include a processor. In various embodiments, the memory 306 may include permanent (e.g., compact disc, etc.), semi-permanent (e.g., a hard drive, etc.), or temporary (e.g., volatile random access memory, etc.) memory. For example, some operations illustrated and/or described herein, may be performed by a controller 304, under control of software, firmware, or a combination thereof. In another example, some components illustrated and/or described herein, may be stored in memory 306.

FIG. 3 is also a block diagram of a wireless device 303 in accordance with an example embodiment of the disclosed subject matter. In one embodiment, the wireless device 301 may include an indoor cellular access point (ICAP) or a mobile station (MS) such as that illustrated in FIG. 2. In one embodiment, the wireless device 301 may include a wireless transceiver 302, a controller 304, and a memory 306. In some embodiments, the transceiver 302 may include a wireless transceiver configured to operate based upon a wireless networking standard (e.g., WiMAX, WiFi, WLAN, etc.). In various embodiments, the controller 304 may include a processor. In various embodiments, the wireless device 303 may include a neighbor list 308 configured to facilitate the searching of the wireless device 303 for wireless networks to join, as described above. In one embodiment, the wireless device 303 may include an ICAP identifier (ID) 310 that is configured to identifier the wireless device 303, as described above. In various embodiments, as described above, the ICAP ID 310 may be included as part of a BSID (not shown). In some embodiments, the neighbor list 308 and ICAP ID 310 may be stored as part of the memory 306.

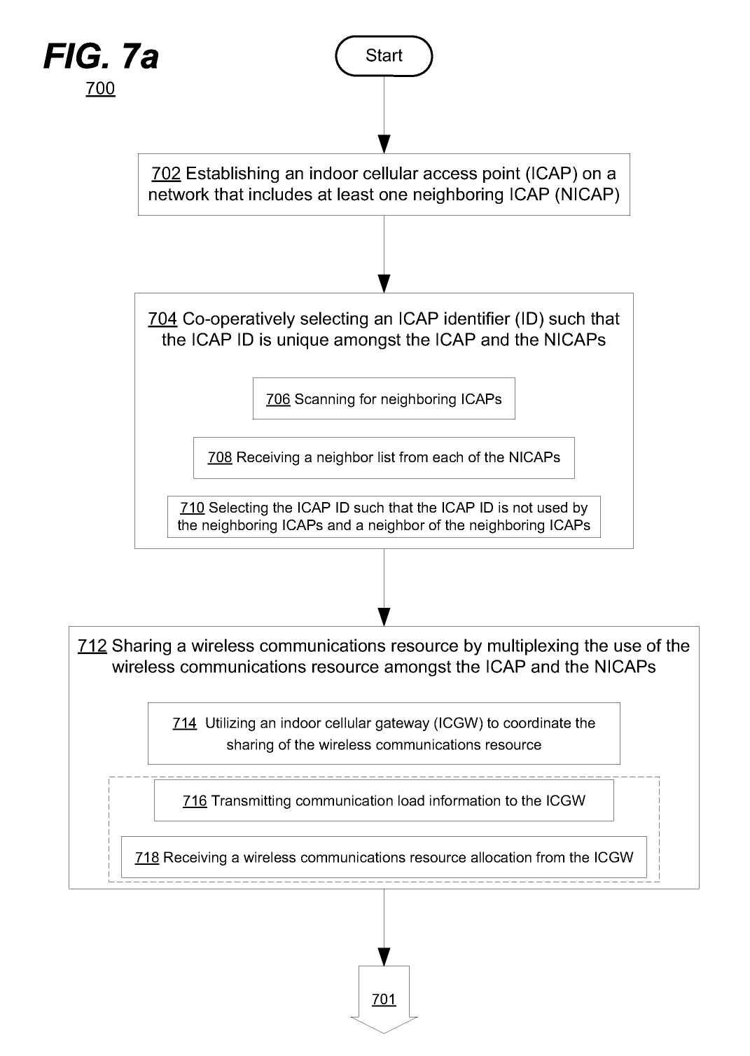

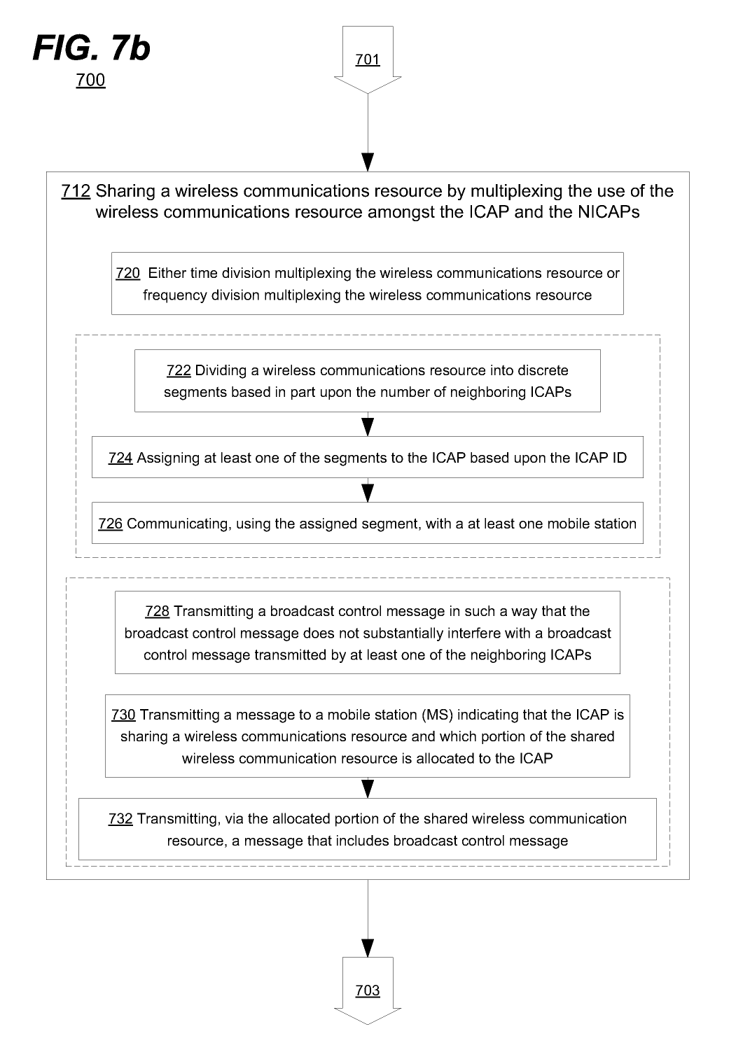

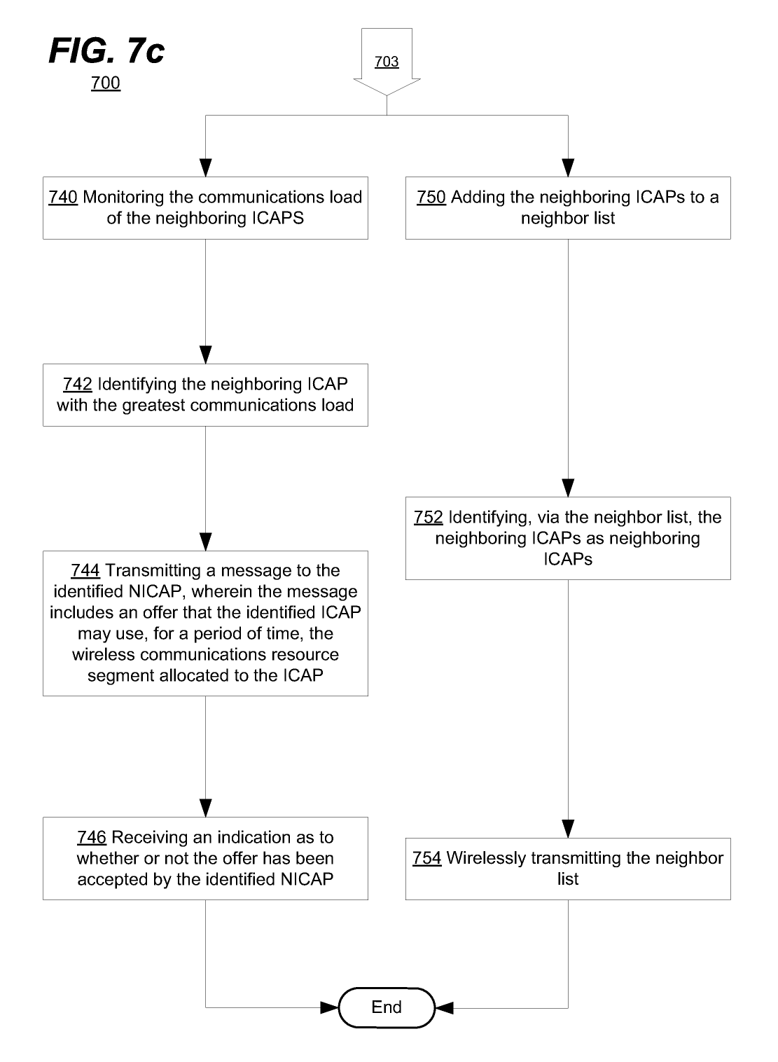

FIG. 7 is a flow chart of an example embodiment of a technique 700 in accordance with the disclosed subject matter. In various embodiments, parts or all of the technique 700 may be the results of the operations of the system 200 of FIG. 2 or system 300 of FIG. 3. Although, it is understood that other systems and timing diagrams may produce technique 700. Furthermore, it is understood that FIGS. 7a, 7b, and 7c represent a single flowchart illustrated on multiple pages and connected via the connectors of Blocks 701 and 703, here-before and here after the multiple pages will simply be referred to as FIG. 7. It is also understood that the actions described and illustrated by FIG. 7c or any other figure are not mutually exclusive.

Block 702 illustrates that, in one embodiment, an indoor cellular access point (ICAP) may be established on a network, as described above. In various embodiments, the network may include at least one neighboring ICAP (NICAP), as described above. In other embodiments, the network may not include any NICAPs when the ICAP is first established on the network. In such an embodiment, the NICAPs may be established after the first ICAP is established on the network. In various embodiments, the transceiver 302 of FIG. 3 or the ICAP 202 of FIG. 2 may perform this action, as described above.

Block 704 illustrates that, in one embodiment, an ICAP identifier (ID) may be co-operatively selected such that the ICAP ID is unique amongst the ICAP and the NICAPs, as described above. Block 706 illustrates that, in one embodiment, selecting may include scanning for neighboring ICAPs, as described above. Block 708 illustrates that, in one embodiment, selecting may include receiving a neighbor list from each of the NICAPs, as described above. Block 710 illustrates that, in one embodiment, selecting may include selecting the ICAP ID such that the ICAP ID is not used by the neighboring ICAPs and a neighbor of the neighboring ICAPs, as described above. In various embodiments, the transceiver 302 or controller 304 of FIG. 3 or the ICAP 202 of FIG. 2 may perform these actions, as described above.

Block 712 illustrates that, in one embodiment, a wireless communications resource may be shared by multiplexing the use of the wireless communications resource amongst the ICAP and the NICAPs, as described above. In various embodiments, the transceiver 302 of FIG. 3 or the ICAP 202 of FIG. 2 may perform this action, as described above.

Block 714 illustrates that, in one embodiment, an indoor cellular gateway (ICGW) may be utilized to coordinate the sharing of the wireless communications resource, as described above. Block 716 illustrates that, in one embodiment, utilizing may include transmitting communication load information to the ICGW, as described above. Block 718 illustrates that, in one embodiment, utilizing may include receiving a wireless communications resource allocation from the ICGW, as described above. In various embodiments, the transceiver 302 of FIG. 3 or the ICAP 202 of FIG. 2 may perform these actions, as described above.

Block 720 illustrates that, in one embodiment, sharing may include either time division multiplexing the wireless communications resource or frequency division multiplexing the wireless communications resource, as described above. In various embodiments, a combination of time and frequency multiplexing may be employed, as described above. In another embodiment, other multiplexing schemes may be used, as described above. In various embodiments, the transceiver 302 of FIG. 3 or the ICAP 202 of FIG. 2 may perform this action, as described above.

Block 722 illustrates that, in one embodiment, sharing may include dividing a wireless communications resource into discrete segments based in part upon the number of neighboring ICAPs, as described above. Block 724 illustrates that, in one embodiment, selecting may include assigning at least one of the segments to the ICAP based upon the ICAP ID, as described above. Block 726 illustrates that, in one embodiment, sharing may include communicating, using the assigned segment, with a at least one mobile station, as described above. In various embodiments, the transceiver 302 or controller 304 of FIG. 3 or the ICAP 202 of FIG. 2 may perform these actions, as described above.

Block 728 illustrates that, in one embodiment, sharing may include transmitting a broadcast control message in such a way that the broadcast control message does not substantially interfere with a broadcast control message transmitted by at least one of the neighboring ICAPs, as described above. Block 730 illustrates that, in one embodiment, sharing may include transmitting a message to a mobile station (MS) indicating that the ICAP is sharing a wireless communications resource and which portion of the shared wireless communication resource is allocated to the ICAP, as described above. Block 732 illustrates that, in one embodiment, sharing may include transmitting, via the allocated portion of the shared wireless communication resource, a message that includes broadcast control message, as described above. In various embodiments, the transceiver 302 or controller 304 of FIG. 3 or the ICAP 202 of FIG. 2 may perform these actions, as described above.

Block 740 the communications load of the neighboring ICAPS may be monitored, as described above. Block 742 illustrates that, in one embodiment, the neighboring ICAP with the greatest communications load may be identified, as described above. Block 744 illustrates that, in one embodiment, a message may be transmitted to the identified NICAP, as described above. In various embodiments, the message may include an offer that the identified ICAP may use, for a period of time, the wireless communications resource segment allocated to the ICAP, as described above. Block 746 illustrates that, in one embodiment, an indication may be received as to whether or not the offer has been accepted by the identified NICAP, as described above. In various embodiments, the transceiver 302 or controller 304 of FIG. 3 or the ICAP 202 of FIG. 2 may perform these actions, as described above.

Block 750 illustrates that, in one embodiment, the neighboring ICAPs may be added to a neighbor list, as described above. Block 752 illustrates that, in one embodiment, the neighboring ICAPs may be identified on the neighbor list as neighboring ICAPs, as described above. Block 754 illustrates that, in one embodiment, the neighbor list may be wirelessly transmitted, as described above. In various embodiments, the transceiver 302 or controller 304 of FIG. 3 or the ICAP 202 of FIG. 2 may perform these actions, as described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A method comprising:
establishing an indoor cellular access point (ICAP) on a network;
co-operatively selecting an ICAP identifier (ID) such that the ICAP ID is unique amongst the ICAP and at least one neighboring ICAP (NICAP); and
sharing a wireless communications resource by multiplexing the use of the wireless communications resource amongst the ICAP and the NICAPs.

2. The method of claim 1 wherein selecting includes
scanning for neighboring ICAPs;
receiving a neighbor list from each of the NICAPs; and
selecting the ICAP ID such that the ICAP ID is not used by the neighboring ICAPs and a neighbor of the neighboring ICAPs.

3. The method of claim 1 wherein sharing includes utilizing an indoor cellular gateway (ICGW) to coordinate the sharing of the wireless communications resource.

4. The method of claim 3 wherein utilizing includes
transmitting communication load information to the ICGW; and
receiving a wireless communications resource allocation from the ICGW.

5. The method of claim 1 wherein sharing includes either time division multiplexing the wireless communications resource or frequency division multiplexing the wireless communications resource.

6. The method of claim 1 wherein sharing includes:
dividing a wireless communications resource into discrete segments based in part upon the number of neighboring ICAPs;
assigning at least one of the segments to the ICAP based upon the ICAP ID; and
communicating, using the assigned segment, with a at least one mobile station (MS).

7. The method of claim 6 further including
monitoring the communications load of the neighboring ICAPS;
identifying the neighboring ICAP with the greatest communications load;
transmitting a message to the identified NICAP, wherein the message includes an offer that the identified ICAP may use, for a period of time, the wireless communications resource segment allocated to the ICAP; and
receiving an indication as to whether or not the offer has been accepted by the identified NICAP.

8. The method of claim 1 wherein sharing includes:
transmitting a broadcast control message in such a way that the broadcast control message does not substantially interfere with a broadcast control message transmitted by at least one of the neighboring ICAPs.

9. The method of claim 8 wherein transmitting includes
transmitting a message to a mobile station (MS) indicating that the ICAP is sharing a wireless communications resource and which portion of the shared wireless communication resource is allocated to the ICAP,
wherein the message is configured to cause the MS to expect communication with the ICAP via the allocated portion of the shared wireless communication resource; and
transmitting, via the allocated portion of the shared wireless communication resource, a message that includes broadcast control message.

10. The method of claim 1 further including:
adding the neighboring ICAPs to a neighbor list;
identifying, via the neighbor list, the neighboring ICAPs as NICAPs; and
wirelessly transmitting the neighbor list.

11. An apparatus comprising:
a wireless transceiver configured to:
establish the apparatus on a network, and
share a wireless communications resource by multiplexing the use of the wireless communications resource amongst the apparatus and at least one neighboring indoor cellular access point (NICAP);
a controller configured to:
co-operatively select an ICAP identifier (ID) such that the ICAP ID is unique amongst the apparatus and the NICAPs; and
a memory configured to:
store the ICAP ID.

12. The apparatus of claim 11 wherein the wireless transceiver is configured to:
scan for neighboring ICAPs, and
receive a neighbor list from each of the NICAPs; and
wherein the controller is configured to select the ICAP ID such that the ICAP ID is not used by the neighboring ICAPs and a neighbor of the neighboring ICAPs.

13. The apparatus of claim 11 wherein the wireless transceiver is configured to:
utilize an indoor cellular gateway (ICGW) to coordinate the sharing of the wireless communications resource.

14. The apparatus of claim 13 wherein the wireless transceiver is configured to:
transmit communication load information to the ICGW; and
receive a wireless communications resource allocation from the ICGW.

15. The apparatus of claim 11 wherein the wireless transceiver is configured to either time division multiplex the wireless communications resource or frequency division multiplex the wireless communications resource.

16. The apparatus of claim 11 wherein the controller is configured to:
divide a wireless communications resource into discrete segments based in part upon the number of neighboring ICAPs, and
assign at least one of the segments to the apparatus based upon the ICAP ID; and
wherein the wireless transceiver is configured to:
communicate, using the assigned segment, with a at least one mobile station (MS).

17. The apparatus of claim 16 wherein the controller is configured to:
monitor the communications load of the neighboring ICAPS, and
identify the neighboring ICAP with the greatest communications load; and
wherein the wireless transceiver is configured to:
transmit a message to the identified NICAP, wherein the message includes an offer that the identified ICAP may use, for a period of time, the wireless communications resource segment allocated to the ICAP, and
receive an indication as to whether or not the offer has been accepted by the identified NICAP.

18. The apparatus of claim 11 wherein the wireless transceiver is configured to:
transmit a broadcast control message in such a way that the broadcast control message does not substantially interfere with a broadcast control message transmitted by at least one of the neighboring ICAPs.

19. The apparatus of claim 18 wherein the wireless transceiver is configured to:
transmit a message to a mobile station (MS) indicating that the apparatus is sharing a wireless communications resource and which portion of the shared wireless communication resource is allocated to the apparatus,
wherein the message is configured to cause the MS to expect communication with the apparatus via the allocated portion of the shared wireless communication resource; and
transmit, via the allocated portion of the shared wireless communication resource, a message that includes broadcast control message.

20. The apparatus of claim 11 wherein the controller is configured to:
add the neighboring ICAPs to a neighbor list, and
identify, via the neighbor list, the neighboring ICAPs as neighboring ICAPs; and
wherein the wireless transceiver is configured to:
transmit the neighbor list.
